(19) United States
(12) Patent Application Publication
(10) Pub. No.: US 2026/0367459 A1
(43) Pub. Date: Nov. 19, 2026

(54) DISPLAY DEVICE INCLUDING NONPOLAR LIQUID

(71) Applicant: Korea Electronics Technology Institute, Seongnam-si (KR)

(72) Inventor: Soon Hyung Kwon, Seongnam-si (KR)

(21) Appl. No.: 19/312,064

(22) Filed: Aug. 27, 2025

(30) Foreign Application Priority Data
May 14, 2025 (KR) 10-2025-0062797

(51) Int. Cl. G02F 1/1675; G02F 1/167

(52) U.S. Cl. CPC G02F 1/1675; G02F 1/167; G02F 2202/28

(57) ABSTRACT

A display device including a nonpolar liquid is proposed. The display device may include a display panel, and a protective film spaced apart from the display panel by a predetermined distance. The display device may also include an intermediate layer configured to pressure-sensitively adhere the protective film to the display panel and to improve visibility.

### CROSS REFERENCE TO RELATED APPLICATION

The present application claims priority to Korean Patent Application No. 10-2025-0062797, filed May 14, 2025, the entire contents of which is incorporated herein for all purposes by this reference.

### BACKGROUND

### Technical Field

The present disclosure relates to a display device including a nonpolar liquid.

### Description of Related Technology

Display devices employ various types of display technologies, such as a liquid crystal display (LCD), an organic light emitting diode (OLED), a plasma display panel (PDP), and an electrophoretic display. Such a display device includes a display panel configured to display information and a protective film coupled to the display panel to protect the display panel. An air gap may be defined between the display panel and the protective film. A difference in refractive index between the protective film, the air gap, and the display panel may cause visibility degradation.

### SUMMARY

One aspect is a display device including a nonpolar liquid between a display panel and a protective film.

Another aspect is a display device in which the display panel and the protective film are pressure-sensitively adhered to each other using a pressure-sensitive adhesive (PSA).

Another aspect is a display device including a nonpolar liquid that includes a display panel, a protective film spaced apart from the display panel by a predetermined distance, and an intermediate layer configured to pressure-sensitively adhere the protective film to the display panel and to improve visibility.

According to an embodiment, the intermediate layer may include a pressure-sensitive adhesive (PSA) layer formed on a lower surface of the protective film and a nonpolar liquid layer formed on the PSA layer.

According to an embodiment, the display device including a nonpolar liquid may further include a case configured to accommodate the display panel having the protective film pressure-sensitively adhered thereto by the intermediate layer.

According to an embodiment, the display device including a nonpolar liquid may further include a sidewall formed along an edge of the protective film and fixed on the display panel to cover an edge of the intermediate layer.

According to an embodiment, the intermediate layer may include a transparent substrate disposed between the display panel and the protective film, a first PSA layer formed on one surface of the transparent substrate, a first nonpolar liquid layer formed on the first PSA layer, a second PSA layer formed on the opposite surface of the transparent substrate, and a second nonpolar liquid layer formed on the second PSA layer.

According to an embodiment, the intermediate layer may be formed in a region corresponding to an active area of the display panel.

According to an embodiment, the intermediate layer may be formed in a ring shape along an edge of an active area of the display panel and may further include a nonpolar liquid within a region corresponding to the active area.

According to an embodiment, the intermediate layer may include a first region having a PSA layer having relatively high density and a second region having a PSA layer having lower density than in the first region.

According to an embodiment, the intermediate layer may include a first region having a PSA layer having relatively low roughness and a second region having a PSA layer having higher roughness than in the first region.

According to an embodiment, the first region may be disposed outside an edge of an active area of the display panel, and the second region may be disposed in a region corresponding to the active area of the display panel.

According to an embodiment, the first region may be formed in a rectangular ring shape surrounding the edge of the active area or may be formed in a shape including a pair of linear segments located opposite each other with respect to the active area.

According to an embodiment, the PSA layer may include a material selected from the group consisting of an acrylic-based material, a rubber-based material, a silicone-based material, and a polyurethane-based material.

The features and advantages of the present disclosure will become more obvious from the following detailed description provided with reference to the accompanying drawings.

Before explaining embodiments of the present disclosure, it is to be understood that the phraseology and terminology used in the following specification and appended claims should not be construed as limited to general and dictionary meanings but be construed as having meanings and concepts according to the spirit of the present disclosure on the basis of the principle that the inventor is permitted to define appropriate terms for the best explanation.

### BRIEF DESCRIPTION OF THE DRAWINGS

The above and other aspects, features, and other advantages of the present disclosure will be more clearly understood from the following detailed description taken in conjunction with the accompanying drawings.

FIG. 1 is a view showing a display device including a nonpolar liquid according to an embodiment.

FIG. 2 is a view showing the display device including a nonpolar liquid according to the embodiment, which further includes a case.

FIG. 3 is an image obtained by photographing a pressure-sensitive adhesive (PSA) layer according to an embodiment.

FIG. 4 is a view showing the display device including a nonpolar liquid according to the embodiment, which further includes a sidewall.

FIG. 5 is a view showing the display device including a nonpolar liquid according to the embodiment, in which an intermediate layer includes a transparent substrate.

FIG. 6 is a plan view showing an active area of the display device including a nonpolar liquid according to the embodiment.

FIG. 7 is a cross-sectional view taken along line A–A' in FIG. 6 to show an intermediate layer formed in a region corresponding to the active area.

FIG. 8 is a cross-sectional view taken along line A–A′ in FIG. 6 to show an intermediate layer formed in a region corresponding to an edge of the active area.

FIG. 9 is a cross-sectional view taken along line A–A′ in FIG. 6 to show regions in which the PSA layer has different densities or roughnesses.

FIG. 10 is a plan view showing a first arrangement of a first region and a second region in which the PSA layer has different densities or roughnesses according to the embodiment.

FIG. 11 is a plan view showing a second arrangement of the first region and the second region in which the PSA layer has different densities or roughnesses according to the embodiment.

FIG. 12 is a plan view showing a third arrangement of the first region and the second region in which the PSA layer has different densities or roughnesses according to the embodiment.

FIG. 13 is a plan view showing a fourth arrangement of the first region and the second region in which the PSA layer has different densities or roughnesses according to the embodiment.

FIG. 14 is a plan view showing a fifth arrangement of the first region and the second region in which the PSA layer has different densities or roughnesses according to the embodiment.

FIG. 15 is a plan view showing a circular display device according to an embodiment.

### DETAILED DESCRIPTION

The aspects, specific advantages, and novel features of embodiments of the present disclosure will become more apparent from the following detailed description and exemplary embodiments taken in conjunction with the accompanying drawings. In assigning reference numerals to components in the drawings, it should be noted that the same components are assigned the same reference numerals wherever possible even though they are depicted in different drawings. Furthermore, in describing embodiments of the present disclosure, a detailed description of the related known art will be omitted when the same may obscure the subject matter of the present disclosure.

Hereinafter, an embodiment of the present disclosure will be described in detail with reference to the accompanying drawings.

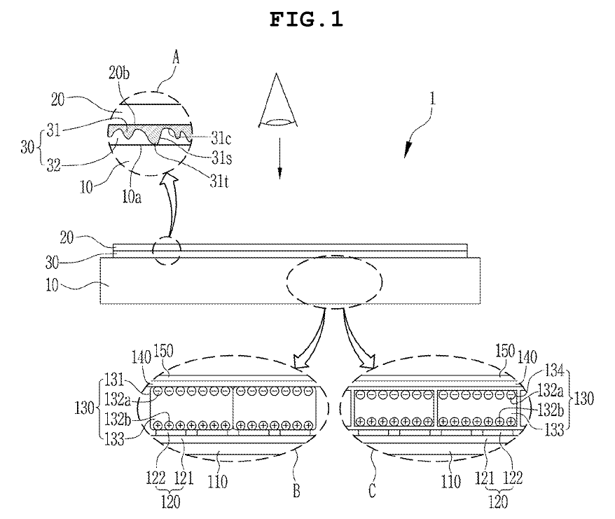

FIG. 1 is a view showing a display device 1 including a nonpolar liquid according to an embodiment.

The display device 1 including a nonpolar liquid according to the embodiment may include a display panel 10, a protective film 20 spaced apart from the display panel 10 by a predetermined distance, and an intermediate layer 30 configured to pressure-sensitively adhere the protective film 20 to the display panel 10 and to improve visibility.

The display panel 10 may display letters, numerals, symbols, images, colors, videos, or other types of information. The display panel 10 may include a light reflective type panel such as an electrophoretic display, an electrochromic display, an electrowetting display, a toner display, or a reflective liquid crystal display, and may also include a light emissive type display such as an LCD, a PDP, an OLED, an LED, or a QD-LED.

The protective film 20 may be positioned at an outermost portion of the display device 1 in order to protect the display panel 10. The protective film 20 may include a glass plate or a synthetic resin film that protects the display panel 10. The protective film 20 may prevent the display panel 10 from being directly impacted by external force. The protective film 20 may also prevent moisture or contaminants from directly reaching the display panel 10. The protective film 20 may be pressure-sensitively adhered to the display panel 10.

The intermediate layer 30 may be disposed between the display panel 10 and the protective film 20. The intermediate layer 30 may have pressure-sensitive adhesiveness to pressure-sensitively adhere the protective film 20 to the display panel 10. The intermediate layer 30 may improve visibility between the display panel 10 and the protective film 20. When the protective film 20 is pressure-sensitively adhered to the display panel 10, visibility may be degraded due to a difference in refractive power between the protective film 20 and the display panel 10. However, the intermediate layer 30 may alleviate the difference in refractive power to improve visibility.

The intermediate layer 30 may include a pressure-sensitive adhesive (PSA) layer 31 formed on a lower surface 20b of the protective film 20 and a nonpolar liquid layer 32 formed on the PSA layer 31. The PSA layer 31 and the nonpolar liquid layer 32 included in the intermediate layer 30 are shown in the enlarged view A in FIG. 1.

The PSA layer 31 may be formed on the surface (lower surface 20b) of the protective film 20 that is attached to the display panel 10. The PSA layer 31 may attach the protective film 20 to the display panel 10 with such a weak force as to allow the protective film 20 to be detached. While bonding using glue or adhesive refers to attaching an element with such a strong force as not to allow the element to be detached, pressure-sensitive adhesion refers to attaching an element with such a weak force as to allow the element to be detached.

The PSA layer 31 may include a material selected from the group consisting of an acrylic-based material, a rubber-based material, a silicone-based material, and a polyurethane-based material. The PSA layer 31 may be formed of an optically transparent material.

The nonpolar liquid layer 32 may be formed on the PSA layer 31. The nonpolar liquid may be a liquid that is not soluble in water and has no polarity. The nonpolar liquid may include hexane, benzene, toluene, chloroform, or various oils. The nonpolar liquid may be formed of an optically transparent material. The nonpolar liquid layer 32 may alleviate a difference in refractive power between the protective film 20, the PSA layer 31, and the display panel 10 and may improve visibility. The protective film 20, the PSA layer 31, and the display panel 10 are formed of different materials, and thus have different refractive indices. Therefore, visibility may be degraded due to a difference in refractive index. The nonpolar liquid layer 32 may be positioned between the protective film 20, the PSA layer 31, and the display panel 10 to alleviate the difference in refractive index.

The nonpolar liquid layer 32 may prevent the generation of air bubbles between the protective film 20 and the display panel 10. When only the PSA layer 31 is present between the protective film 20 and the display panel 10, air bubbles may be formed between the protective film 20 and the display panel 10. Because air has a refractive index significantly different from that of the protective film 20 or the display panel 10, it may degrade visibility. Because the nonpolar liquid layer 32 is fluid, it may prevent the generation of air bubbles when the protective film 20 including the intermediate layer 30 is pressure-sensitively adhered to the display panel 10.

Overall, the PSA layer 31 may be formed on the lower surface 20b of the protective film 20, the nonpolar liquid layer 32 may be formed on the PSA layer 31, and the intermediate layer 30 including the PSA layer 31 and the nonpolar liquid layer 32 may be pressure-sensitively adhered to an upper surface 10a of the display panel 10. Because the nonpolar liquid layer 32 is fluid, a portion of the PSA layer 31 may be pressure-sensitively adhered to the display panel 10 to fix the protective film 20.

Referring to the enlarged view A in FIG. 1, the PSA layer 31 may have an irregularly formed surface 31s. A concave-convex pattern may be present on the surface 31s of the PSA layer 31, and the nonpolar liquid layer 32 may be positioned in the recessed portions of the PSA layer 31. Due to the nonpolar liquid layer 32, not all portions of the PSA layer 31 are pressure-sensitively adhered to the display panel 10. A protruding portion 31t protruding from the surface 31s of the PSA layer 31 may be pressure-sensitively adhered to the display panel 10. Therefore, the configuration in which the protective film 20 is pressure-sensitively adhered to the display panel 10 using the PSA layer 31 on which the nonpolar liquid layer 32 is formed may exhibit low pressure-sensitive adhesion performance compared to a configuration in which the protective film 20 is pressure-sensitively adhered to the display panel 10 using only the PSA layer 31.

Even though the pressure-sensitive adhesion performance of the intermediate layer 30 is reduced, it is still sufficient to pressure-sensitively adhere the protective film 20 to the display panel 10 and to fix the protective film 20 at a desired position. Because the pressure-sensitive adhesion performance is low, if the protective film 20 is not attached at a desired position on the display panel 10, the attachment position of the protective film 20 may be easily corrected. For example, if the protective film 20 attached to the display panel 10 is pushed toward a desired position, the protective film 20 may slide along the surface of the display panel 10 and reach the desired position while remaining pressure-sensitively adhered to the display panel 10.

When the protective film 20 is pressure-sensitively adhered to the display panel 10 using the PSA layer 31 on which the nonpolar liquid layer 32 is formed, a space between the PSA layer 31 and the display panel 10 is very small. Therefore, forces such as capillary action, a pressure difference between the space between the PSA layer 31 and the display panel 10 and an external space, and surface tension between molecules of the nonpolar liquid may act on the nonpolar liquid, and the nonpolar liquid may not be discharged to the outside of an edge of the protective film 20.

The following description will be given with reference to the enlarged views B and C in FIG. 1.

The display panel 10 may be an electrophoretic display panel. The display panel 10 may include a lower substrate 110, a lower electrode layer 120 formed on the lower substrate 110, a display layer 130 formed on the lower electrode layer 120 and configured to display information through movement of electrophoretic particles 132a and 132b, an upper electrode layer 140 formed on the display layer 130, and an upper substrate 150 formed on the upper electrode layer 140.

The lower substrate 110 may support the display panel 10.

The lower electrode layer 120 may be formed on the lower substrate 110. The lower electrode layer 120 may include a signal transmission layer 121 and a plurality of lower electrodes 122 formed on an upper side of the signal transmission layer 121. The signal transmission layer 121 may transmit an electrical signal to each of the plurality of lower electrodes 122. One lower electrode 122 or a plurality of lower electrodes 122 may operate as a pixel.

The display layer 130 may include a capsule structure 131 or a partition wall structure 134 therein. The capsule structure 131 may contain a plurality of particles 132a and 132b that exhibit colors and a fluid 133 in which the particles 132a and 132b are movable. The particles 132a and 132b may have a negative or positive electric charge. The particles 132a and 132b may move in response to an electric field generated between the upper electrode and the lower electrodes 122. If the first particles 132a or the second particles 132b move toward the upper substrate 150 according to the direction of the electric field, the colors of the particles 132a or 132b that have moved toward the upper substrate 150 may be displayed to the outside.

The partition wall structure 134 may form a plurality of compartments that contain a plurality of particles 132a and 132b and a fluid 133. The partition wall structure 134 may alternatively be formed in a cup-shaped structure. The fluid 133 and the plurality of particles 132a and 132b may be contained in the plurality of compartments formed by the partition wall structure 134.

The upper electrode layer 140 may be formed on an upper side of the display layer 130. The upper electrode layer 140 may be formed as a single electrode. Even though the upper electrode layer 140 is formed as a single electrode, because the lower electrode layer 120 includes the plurality of lower electrodes 122, the direction of the electric field in each region may be varied depending on the electrical signal applied to each of the lower electrodes 122. The upper electrode layer 140 may be formed of a material that is transparent in the visible spectrum. In some cases, the upper electrode layer 140 may be formed of a material that is transparent in various wavelength bands.

The upper substrate 150 may be formed on the upper electrode layer 140. The upper substrate 150 may be formed of a transparent material. The upper substrate 150 may protect and electrically insulate the upper electrode layer 140.

The display panel 10 may further include an insulating layer or an adhesive layer in addition to the lower substrate 110, the lower electrode layer 120, the display layer 130, the upper electrode layer 140, and the upper substrate 150.

When the display panel 10 employs a display type other than the electrophoretic display, the display panel 10 may further include an emission layer, a light diffusion layer, and other necessary components.

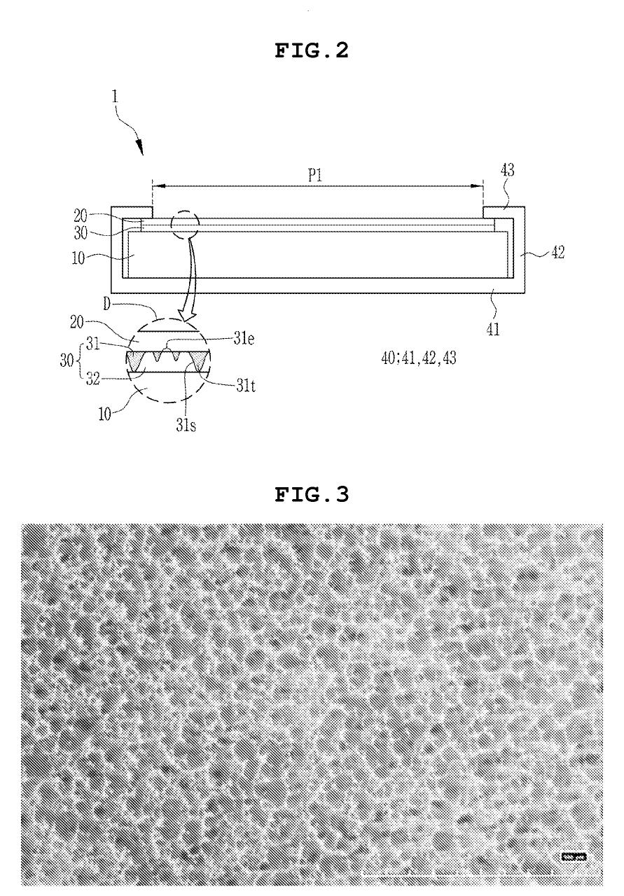

FIG. 2 is a view showing the display device 1 including a nonpolar liquid according to the embodiment, which further includes a case 40.

The display device 1 including a nonpolar liquid may further include a case 40 configured to accommodate the display panel 10 to which the protective film 20 is pressure-sensitively adhered by the intermediate layer 30.

The case 40 may accommodate the display panel 10. The case 40 may expose an active area P1 of the display panel 10 and may cover an area peripheral to the active area P1 of the display panel 10. The case 40 may include a lower case 41, a side case 42, and a front case 43. The lower case 41, the side case 42, and the front case 43 may be connected to each other to accommodate the display panel 10. The front case 43 may define an open space corresponding to the active area P1 of the display panel 10.

Although the front case 43 is illustrated in FIG. 2 as covering a portion of the protective film 20, the front case 43 may alternatively cover an edge of the upper surface 10a of the display panel 10. That is, the front case 43 may not be in contact with the protective film 20. The protective film 20 may be a cover glass made of a glass material. The cover glass may be bonded and fixed to the front case 43.

FIG. 3 is an image obtained by photographing the PSA layer 31 according to an embodiment. The PSA layer 31 will now be described with reference to FIG. 3 together with the enlarged view A in FIG. 1 and the enlarged view D in FIG. 2.

As shown in FIG. 3, the surface 31s of the PSA layer 31 is formed irregularly. That is, the surface 31s of the PSA layer 31 is not flat. In addition, the PSA layer 31 may include partially non-applied regions depending on the degree to which the pressure-sensitive adhesive material is applied. The cross sections of the PSA layer 31 having the surface 31s formed irregularly as shown in FIG. 3 are shown in the enlarged view A in FIG. 1 and the enlarged view D in FIG. 2.

The enlarged view A in FIG. 1 shows a state in which the pressure-sensitive adhesive material is relatively densely applied, and the enlarged view D in FIG. 2 shows a state in which the pressure-sensitive adhesive material is relatively sparsely applied.

As shown in the enlarged view A in FIG. 1, the pressure-sensitive adhesive material may be applied to entirely cover the lower surface 20b of the protective film 20. In this case, protruding portions 31t and recessed portions 31c may be formed on the surface 31s of the PSA layer 31. The protruding portions 31t of the PSA layer 31 may be in contact with and pressure-sensitively adhered to the display panel 10. The recessed portions 31c of the PSA layer 31 may receive the nonpolar liquid layer 32.

As shown in the enlarged view D in FIG. 2, the pressure-sensitive adhesive material may be sparsely applied to the lower surface 20b of the protective film 20. In this case, regions not covered by the pressure-sensitive adhesive material may be present on the lower surface 20b of the protective film 20. The PSA layer 31 may include protruding portions 31t formed by application of the pressure-sensitive adhesive material and portions 31e to which the pressure-sensitive adhesive material is not applied. The protruding portions 31t of the PSA layer 31 may be in contact with and pressure-sensitively adhered to the display panel 10. The nonpolar liquid layer 32 may be received in the portions 31e to which the pressure-sensitive adhesive material is not applied.

That is, the relative ratio of the nonpolar liquid layer 32 to the PSA layer 31 may be controlled by adjusting the amount or density of the pressure-sensitive adhesive material applied. In the process of forming the PSA layer 31, if the density of the pressure-sensitive adhesive material applied is high, a relatively small amount of nonpolar liquid may be used, and if the density of the pressure-sensitive adhesive material applied is low, a relatively large amount of nonpolar liquid may be used. If the density of the pressure-sensitive adhesive material applied is low and thus a large portion of the nonpolar liquid layer 32 is in direct contact with the lower surface 20b of the protective film 20, visibility may be improved more greatly. If the density of the pressure-sensitive adhesive material applied is high and thus a large number of protruding portions 31t of the PSA layer 31 are formed, the protective film 20 may be pressure-sensitively adhered to the display panel 10 with a larger fixing force. As such, the pressure-sensitive adhesion performance and the degree of visibility improvement may be controlled by adjusting the amounts of the pressure-sensitive adhesive material and the nonpolar liquid applied.

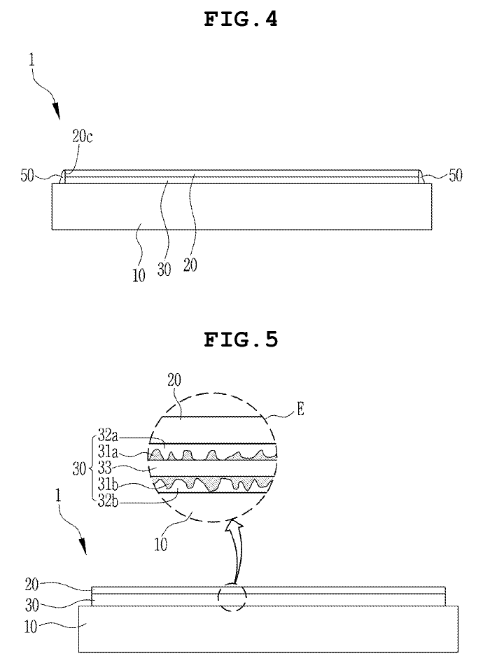

FIG. 4 is a view showing the display device 1 including a nonpolar liquid according to the embodiment, which further includes a sidewall 50.

The display device 1 including a nonpolar liquid may further include a sidewall 50 that is formed along an edge of the protective film 20 and is fixed on the display panel 10 to cover an edge of the intermediate layer 30.

The sidewall 50 may be formed in a state in which the protective film 20 is pressure-sensitively adhered to the display panel 10 via the intermediate layer 30. The sidewall 50 may be formed to extend from a side surface 20c of the protective film 20 to the upper surface 10a of the display panel 10. The sidewall 50 may be formed of a material through which the nonpolar liquid does not leak. The sidewall 50 may fix the position of the protective film 20 on the display panel 10. The sidewall 50 may be formed in an overall rectangular ring shape along the edge of the protective film 20. Therefore, the nonpolar liquid may be contained in a space defined by the sidewall 50, the display panel 10, and the protective film 20. As a result, even when the display panel 10 is placed upright and left for an extended period of time, the nonpolar liquid may not leak to the outside.

FIG. 5 is a view showing the display device 1 including a nonpolar liquid according to the embodiment, in which the intermediate layer 30 includes a transparent substrate 33.

According to the embodiment, the intermediate layer 30 may include a transparent substrate 33 positioned between the display panel 10 and the protective film 20, a first PSA layer 31a formed on one surface of the transparent substrate 33, a first nonpolar liquid layer 32a formed on the first PSA layer 31a, a second PSA layer 31b formed on the opposite surface of the transparent substrate 33, and a second nonpolar liquid layer 32b formed on the second PSA layer 31b.

The first and second PSA layers 31a and 31b are identical to the PSA layer 31 described above with reference to FIGS. 1-3, and thus redundant descriptions thereof will be omitted. The first and second nonpolar liquid layers 32a and 32b are identical to the nonpolar liquid layer 32 described above with reference to FIGS. 1-3, and thus redundant descriptions thereof will be omitted.

The transparent substrate 33 may be formed of an optically transparent material. The transparent substrate 33 may be formed of a synthetic resin film, glass, or other materials. The transparent substrate 33 may further contain pearls, glitter, dyes, pigments, or various other decorative elements.

The first PSA layer 31a and the first nonpolar liquid layer 32a, which are formed on one surface of the transparent substrate 33, may be pressure-sensitively adhered to the protective film 20. The second PSA layer 31b and the second nonpolar liquid layer 32b, which are formed on the opposite surface of the transparent substrate 33, may be pressure-sensitively adhered to the display panel 10.

The density or roughness of the pressure-sensitive adhesive material in the first PSA layer 31a and the density or roughness of the pressure-sensitive adhesive material in the second PSA layer 31b may differ from each other. For example, the first PSA layer 31a may have relatively high roughness, and the second PSA layer 31b may have relatively low roughness. When one of the first PSA layer 31a and the second PSA layer 31b has lower roughness, a region pressure-sensitively adhered by the corresponding PSA layer may have lower pressure-sensitive adhesion performance.

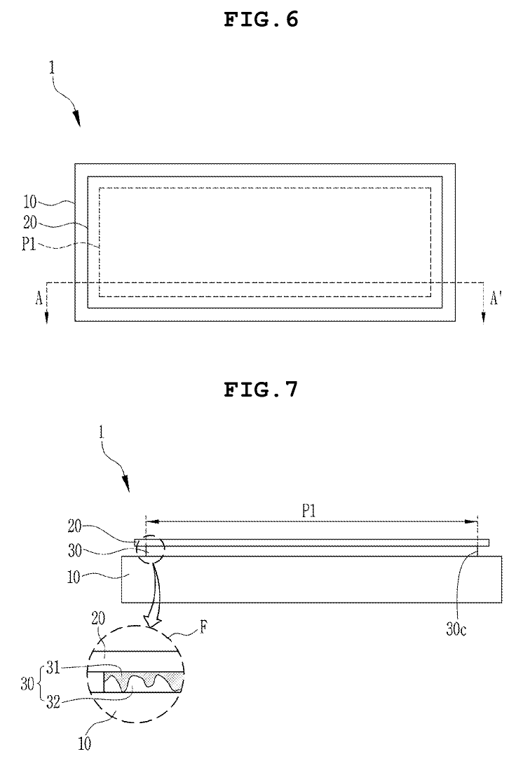

FIG. 6 is a plan view showing an active area P1 of the display device 1 including a nonpolar liquid according to the embodiment. FIG. 7 is a cross-sectional view taken along line A–A' in FIG. 6 to show the intermediate layer 30 formed in a region corresponding to the active area P1.

The intermediate layer 30 may be formed in a region corresponding to the active area P1 of the display panel 10. The active area P1 may be positioned in the middle of the display panel 10. The active area P1 is an area of the display panel 10 in which information is displayed. An area peripheral to the active area P1 is an area in which components such as electrode patterns necessary for displaying information through the active area P1 are disposed, that is, a non-active area. The protective film 20 may be formed to have a size that covers a region corresponding to the active area P1 of the display panel 10. The protective film 20 may be pressure-sensitively adhered at a position covering the active area P1 of the display panel 10.

The intermediate layer 30 may be formed in a region corresponding to the active area P1 of the display panel 10 in order to enhance visibility. In FIG. 6, the active area P1 is indicated by a dotted line. Referring to FIG. 7, the intermediate layer 30 may be formed only in the region corresponding to the active area P1 shown in FIG. 6. Referring to the enlarged view E in FIG. 7, a side surface 30c of the intermediate layer 30 may be exposed to an empty space.

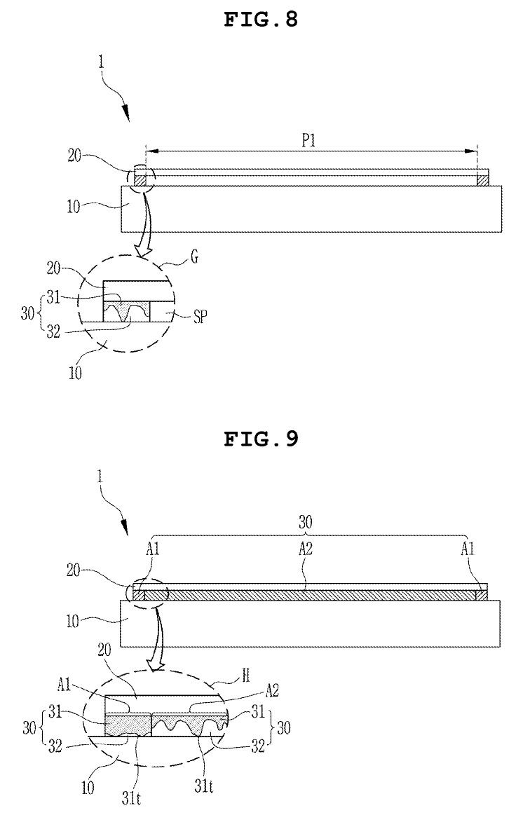

FIG. 8 is a cross-sectional view taken along line A–A′ in FIG. 6 to show an intermediate layer 30 formed in a region corresponding to an edge of the active area P1. The intermediate layer 30 will now be described with reference to FIG. 8 together with FIG. 6.

The intermediate layer 30 may be formed in a ring shape along the edge of the active area P1 of the display panel 10, and may further include a nonpolar liquid in the region corresponding to the active area P1. As shown in FIG. 6 and the enlarged view G in FIG. 8, the intermediate layer 30 may be formed in a region outside the active area P1. The intermediate layer 30 may be formed in an overall rectangular ring shape such that a space SP corresponding to the active area P1 is defined thereinside. A nonpolar liquid, which is identical to the nonpolar liquid layer 32 formed on the PSA layer 31, may be positioned in the space SP defined inside the rectangular ring-shaped intermediate layer 30. Because the nonpolar liquid present in the space SP is surrounded by the intermediate layer 30, the nonpolar liquid may not leak to the outside. Because the space SP corresponding to the active area P1 is filled only with the nonpolar liquid, visibility may be further enhanced.

FIG. 9 is a cross-sectional view taken along line A–A′ in FIG. 6 to show regions in which the PSA layer 31 has different densities or roughnesses.

As shown in FIG. 6 and the enlarged view H in FIG. 9, the intermediate layer 30 may include a first region A1 in which the PSA layer 31 has relatively high density and a second region A2 in which the PSA layer 31 has lower density than in the first region A1. Alternatively, the intermediate layer 30 may include a first region A1 in which the PSA layer 31 has relatively low roughness and a second region A2 in which the PSA layer 31 has higher roughness than in the first region A1.

As described above with reference to FIGS. 1, 2, and 3, the density of the PSA layer 31 and the distribution of the protruding portions 31t of the surface 31s of the PSA layer 31 may be varied depending on whether the pressure-sensitive adhesive material is densely or sparsely applied in the process of forming the PSA layer 31. A large difference in height between the protruding portions 31t and the recessed portions 31c formed on the surface 31s of the PSA layer 31 may represent high roughness.

If the density of the PSA layer 31 is relatively high, the roughness of the PSA layer 31 may be relatively low. Accordingly, the first region A1 may be a region in which the PSA layer 31 has high density and low roughness. Because the PSA layer 31 in the first region A1 has relatively low roughness, the size of the space in which the nonpolar liquid is received between the protruding portions 31t of the surface 31s of the PSA layer 31 may be small, and the number and area of the protruding portions 31t in contact with the display panel 10 may be large. Therefore, the first region A1 may exhibit higher pressure-sensitive adhesion performance than the second region A2. In this case, the protective film 20 and the display panel 10 may be pressure-sensitively adhered to each other with a larger fixing force in the portion of the intermediate layer 30 corresponding to the first region A1.

If the density of the PSA layer 31 is relatively low, the roughness of the PSA layer 31 may be relatively high. Accordingly, the second region A2 may be a region in which the PSA layer 31 has low density and high roughness. Because the PSA layer 31 in the second region A2 has relatively high roughness, the size of the space in which the nonpolar liquid is received between the protruding portions 31t of the surface 31s of the PSA layer 31 may be large, and the number and area of the protruding portions 31t in contact with the display panel 10 may be small. Therefore, the second region A2 may exhibit lower pressure-sensitive adhesion performance than the first region A1, but visibility may be greatly improved in the second region A2. In this case, the protective film 20 and the display panel 10 may be pressure-sensitively adhered to each other with a smaller fixing force in the portion of the intermediate layer 30 corresponding to the second region A2.

The pressure-sensitive adhesion performance in a desired region of the protective film 20 may be controlled by adjusting the locations of the first region A1 and the second region A2 and the ratio of the first region A1 to the second region A2 in the intermediate layer 30.

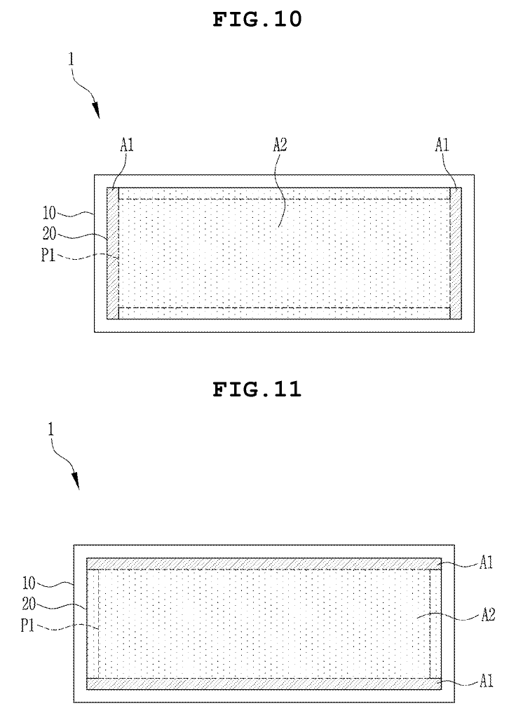

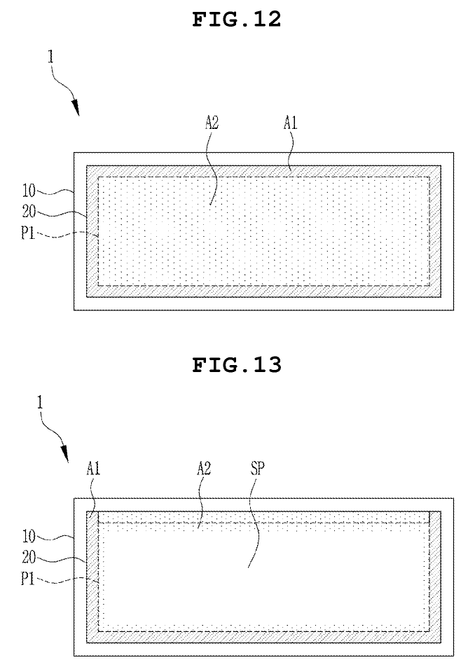

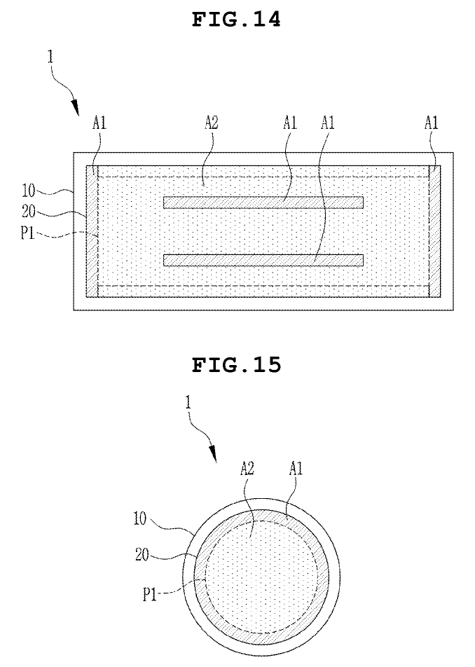

FIG. 10 is a plan view showing a first arrangement of the first region A1 and the second region A2 in which the PSA layer 31 has different densities or roughnesses according to the embodiment. FIG. 11 is a plan view showing a second arrangement of the first region A1 and the second region A2 in which the PSA layer 31 has different densities or roughnesses according to the embodiment. FIG. 12 is a plan view showing a third arrangement of the first region A1 and the second region A2 in which the PSA layer 31 has different densities or roughnesses according to the embodiment. FIG. 13 is a plan view showing a fourth arrangement of the first region A1 and the second region A2 in which the PSA layer 31 has different densities or roughnesses according to the embodiment. FIG. 14 is a plan view showing a fifth arrangement of the first region A1 and the second region A2 in which the PSA layer 31 has different densities or roughnesses according to the embodiment. The arrangement of the first region A1 and the second region A2 will now be described with reference to FIGS. 10-14 together with FIG. 9.

In the intermediate layer 30 shown in FIGS. 10, 11, 12, and 13, the first region A1 may be located outside the edge of the active area P1 of the display panel 10, and the second region A2 may be located in a region corresponding to the active area P1 of the display panel 10. The second region A2 may extend outside the edge of the active area P1. In the second region A2 of the intermediate layer 30, the nonpolar liquid layer 32 may be formed to be relatively thick, thereby further improving visibility. Accordingly, visibility may be further improved by forming the second region A2 in the region corresponding to the active area P1. In the first region A1 of the intermediate layer 30, the PSA layer 31 may be formed to be relatively thick, thereby exhibiting higher pressure-sensitive adhesion performance. Therefore, the edge of the protective film 20 may be more reliably pressure-sensitively adhered to the display panel 10 by placing the first region A1 in a region outside the edge of the active area P1.

The first region A1 may be formed in a rectangular ring shape surrounding the edge of the active area P1 or may be formed in a shape including a pair of linear segments located opposite each other with respect to the active area P1.

In the first arrangement shown in FIG. 10 and the second arrangement shown in FIG. 11, the first region A1 is located outside the edge of the active area P1 of the display panel 10, and the second region A2 is located in the region corresponding to the active area P1 of the display panel 10. In the first arrangement shown in FIG. 10, a pair of linear segments of the first region A1 is disposed along respective short sides of the rectangular active area P1 so as to be opposite each other. In the second arrangement shown in FIG. 11, a pair of linear segments of the first region A1 is disposed along respective long sides of the rectangular active area P1 so as to be opposite each other. Either the first arrangement or the second arrangement may be selectively adopted based on the specific design of the display device 1.

In the third arrangement shown in FIG. 12, the first region A1 is formed in a rectangular ring shape surrounding the active area P1. Because the first region A1 surrounds the active area P1, it may be possible to prevent the nonpolar liquid within the second region A2 from leaking to the outside. Accordingly, a lateral sealing element, such as the sidewall 50 described above with reference to FIG. 4, may be omitted.

In the fourth arrangement shown in FIG. 13, the first region A1 includes three linear segments, among which a pair of linear segments is disposed along respective short sides of the active area P1 so as to be opposite each other and the other linear segment is disposed along the lower one of the long sides of the active area P1. The upper long side of the active area P1, along which the first region A1 is not disposed, may be a portion that is oriented upward based on the direction of gravity when the display device 1 is in use. For example, if the display device 1 is applied to a television, the display device 1 may adopt the fourth arrangement in which the long side of the active area P1, along which the first region A1 is not disposed, is oriented upward based on the direction of gravity. In the fourth arrangement, the first region A1, in which the PSA layer 31 is formed to be relatively thick, is disposed along the left and right sides of the active area P1 and the lower side of the active area P1 that is oriented downward based on the direction of gravity, thereby preventing the nonpolar liquid from leaking even when the display device 1 is used in an upright orientation for an extended period of time.

In the fourth arrangement, the second region A2 may be formed to cover the active area P1, and a space SP, which is filled with a nonpolar liquid, may be defined within the second region A2. The space SP, which is filled with a nonpolar liquid, may be a portion in which the intermediate layer 30 is not formed between the display panel 10 and the protective film 20. Because the space SP filled with the nonpolar liquid covers most of the active area P1, visibility may be greatly improved.

The fifth arrangement shown in FIG. 14 corresponds to a structure in which the second region A2 is disposed to cover the active area P1. In the fifth arrangement, the first region A1 includes four linear segments, among which a pair of linear segments is disposed along respective short sides of the active area P1 so as to be opposite each other and the other pair of linear segments is disposed inside the active area P1 and extends in a direction parallel to the long sides of the active area P1. In the fifth arrangement, the pair of linear segments of the first region A1 disposed inside the active area P1 may more reliably pressure-sensitively adhere the protective film 20 to the display panel 10. As the area of the active area P1 increases, the area of the pair of linear segments of the first region A1 disposed inside the active area P1 also increases. Because the central portion of the active area P1 is far from the first region A1 disposed outside the edge of the active area P1, the force with which the protective film 20 is pressure-sensitively adhered to the display panel 10 may be weak. The pair of linear segments of the first region A1 disposed inside the active area P1 may allow a portion of the protective film 20 corresponding to the active area P1 to be more reliably pressure-sensitively adhered to the display panel 10. The area, pattern, length, and width of the pair of linear segments of the first region A1 disposed inside the active area P1 may be varied depending on the design of the display device 1.

FIG. 15 is a plan view showing a circular display device 1 according to an embodiment.

The display panel 10 and the protective film 20 may be circular. The circular display device 1 may be used as a screen of a smartwatch or as a display for special purposes. The active area P1 of the display panel 10 may be concentric with the display panel 10. The first region A1 may be disposed outside the edge of the active area P1 of the display panel 10. The second region A2 may be disposed in the region corresponding to the active area P1.

The display device 1 may have not only a circular shape but also various other shapes, such as an elliptical shape, a triangular shape, or a polygonal shape. Generally, the active area P1 may be formed in a shape similar to the shape of the display panel 10, the first region A1 may be formed to surround the active area P1, and the second region A2 may be formed to cover the active area P1. The arrangement of the first region A1 and the second region A2 may be variously modified depending on the shape, size, or intended purpose of the display panel 10.

As described above, according to the present disclosure, a nonpolar liquid may be positioned between the display panel 10 and the protective film 20, thereby improving visibility. In addition, the nonpolar liquid layer 32 may be formed on the PSA layer 31 such that a portion of the PSA layer 31 pressure-sensitively adheres the protective film 20 to the display panel 10, thereby facilitating correction of the pressure-sensitive adhesion position of the protective film 20.

As is apparent from the above description, according to an embodiment of the present disclosure, a nonpolar liquid may be positioned between the display panel and the protective film, thereby improving visibility.

According to an embodiment of the present disclosure, the pressure-sensitive adhesion position of the protective film may be easily corrected.

Although exemplary embodiments of the present disclosure have been illustrated and described in order to exemplify the principle of the present disclosure, the present disclosure is not limited to the exemplary embodiments. It will be understood that various modifications and changes can be made by those skilled in the art without departing from the spirit and scope of the disclosure as defined by the appended claims.

What is claimed is:

1. A display device including a nonpolar liquid, comprising:
a display panel;
a protective film spaced apart from the display panel by a predetermined distance; and
an intermediate layer configured to pressure-sensitively adhere the protective film to the display panel and to improve visibility.

2. The display device according to claim 1, wherein the intermediate layer comprises:
a pressure-sensitive adhesive (PSA) layer formed on a lower surface of the protective film; and
a nonpolar liquid layer formed on the PSA layer.

3. The display device according to claim 1, further comprising a case configured to accommodate the display panel comprising the protective film pressure-sensitively adhered thereto by the intermediate layer.

4. The display device according to claim 1, further comprising a sidewall formed along an edge of the protective film and fixed on the display panel to cover an edge of the intermediate layer.

5. The display device according to claim 1, wherein the intermediate layer comprises:
a transparent substrate disposed between the display panel and the protective film;
a first PSA layer formed on one surface of the transparent substrate;
a first nonpolar liquid layer formed on the first PSA layer;
a second PSA layer formed on an opposite surface of the transparent substrate; and
a second nonpolar liquid layer formed on the second PSA layer.

6. The display device according to claim 1, wherein the intermediate layer is formed in a region corresponding to an active area of the display panel.

7. The display device according to claim 1, wherein the intermediate layer is formed in a ring shape along an edge of an active area of the display panel and wherein the intermediate layer further comprises a nonpolar liquid within a region corresponding to the active area.

8. The display device according to claim 2, wherein the intermediate layer comprises:
a first region comprising a PSA layer having relatively high density; and
a second region comprising a PSA layer having lower density than in the first region.

9. The display device according to claim 2, wherein the intermediate layer comprises:
a first region comprising a PSA layer having relatively low roughness; and
a second region comprising a PSA layer having higher roughness than in the first region.

10. The display device according to claim 8, wherein the first region is disposed outside an edge of an active area of the display panel, and
wherein the second region is disposed in a region corresponding to the active area of the display panel.

11. The display device according to claim 10, wherein the first region is formed in a rectangular ring shape surrounding the edge of the active area or is formed in a shape comprising a pair of linear segments located opposite each other with respect to the active area.

12. The display device according to claim 2, wherein the PSA layer comprises at least one of an acrylic-based material, a rubber-based material, a silicone-based material, or a polyurethane-based material.
